(19) United States
(12) Patent Application Publication
(10) Pub. No.: US 2009/0049844 A1
(43) Pub. Date: Feb. 26, 2009

(54) Circuit Arrangement for a Peltier Module

(75) Inventors: Hasan Gökcer Albayrak, Berlin (DE); Klaus Grunert, Berlin (DE); Thomas Ludenia, Falkensee (DE); Guenter Steffens, Dallgow-Doeberitz (DE); Andreas Stolze, Falkensee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeräte GmbH, München (DE)

(21) Appl. No.: 12/086,463

(22) PCT Filed: Nov. 24, 2006
(86) PCT No.: PCT/EP2006/068874

§ 371 Date: Jun. 12, 2008

(30) Foreign Application Priority Data
Dec. 15, 2005 (DE) 10 2005 060 041.7

(51) Int. Cl. F25B 21/02; F25B 21/04; G05D 23/19

(52) U.S. Cl. 62/3.7; 62/3.3; 236/1 F

(57) ABSTRACT

A circuit arrangement for a Peltier module for use in a Peltier heat pump for a tumble dryer with the circuit arrangement including a Peltier module having at least one series arrangement of Peltier elements actuable by a DC voltage. Also included is a rectifier operatively associated with a power supply and at least one series arrangement of Peltier elements for producing a rectified DC voltage for use by said Peltier elements. The number of Peltier elements and the manufacturer type of Peltier elements are selected in a manner wherein the Peltier elements of the series arrangement are operated by actuating the series arrangement with the rectified power supply at an operating voltage that is suitable for the use of the Peltier module in a Peltier heat pump.

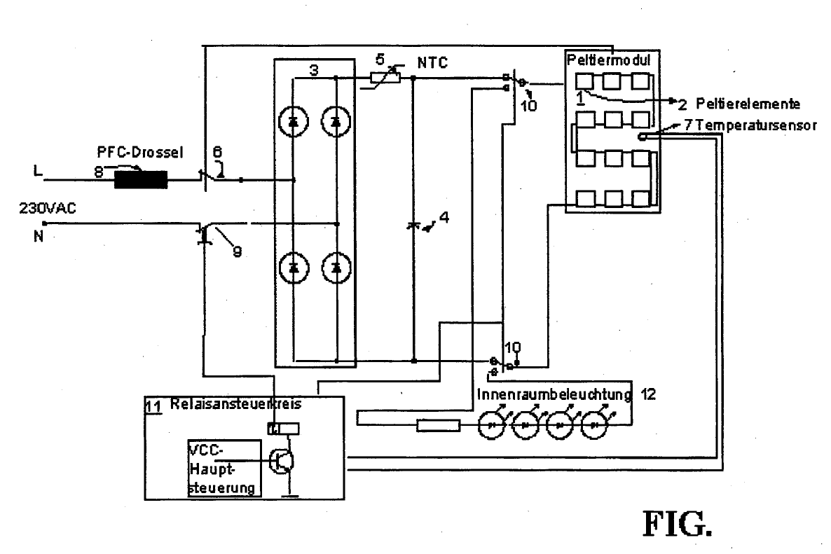

The invention relates to a circuit arrangement for a Peltier module for use in a Peltier heat pump for a tumble dryer, in which the Peltier module includes at least one series arrangement consisting of Peltier elements, and each series arrangement can be actuated with DC voltage.

A document which was available for downloading on 25 Nov. 2005 from the Internet address http://de.wikipedia.org/wiki/Peltier-Element discloses a Peltier element, which in terms of design and function has the design described in the aforementioned. The half elements of said Peltier element are configured to be column-shaped or rectangular and consist of doped semiconductors as construction materials. The semiconductors are in particular bismuth telluride and a p-conducting doped semiconductor and an n-conducting doped semiconductor are used. One respective half element from the p-conducting doped semiconductor and one respective half element from the n-conducting doped semiconductor are in each case connected to each other at one end via a circuit board, also known as a metal bridge, and at another end, which is opposite the aforementioned one end, by a respective further circuit board comprising a further half element or a connection contact for connecting the Peltier element to an electric power supply.

Further suggestions on the basic principles, use-related selection and fitting of Peltier elements are to be found in documents that were available for downloading on 25. Nov. 2005 from the Internet-addresses http://www.quick-ohm.de/waerme/download/Erlaeuterung-zu-Peltier elements.pdf and http://www.quick-ohm.de/waerme/download/Einbau.pdf.

DE 1 410 206 A discloses a washing machine in which laundry can be not only washed, but also dried. That document discloses a number of alternatives for the additional installations that are required for this purpose; in particular, an electrical heating device to heat up an air stream that is used to dry laundry and a simple heat exchanger to cool the heated air stream after the laundry has been loaded can be provided, but the heater and cooler units may also form part of a heat pump device. Die heat pump device may be a heat pump device that operates using Peltier elements to make use of the thermoelectric effect.

An English abstract for JP 08 057 194 from the database “Patent Abstracts of Japan” discloses a device for the drying of laundry, which device again corresponds to the type described in the introductory part of the description. Said device has a first duct system that contains, in addition to a heater and a cooler that both form part of a heat pump device that can be operated thermoelectrically, an additional heat exchanger connected upstream of the cooler in order to cool the air stream removed from the laundry and an additional heating device connected downstream of the heater for further heating the air stream before the laundry is loaded.

Depending on the number of Peltier elements in a series arrangement and on the ratings for the Peltier elements, that is depending on the manufacturer type of the Peltier elements, the series arrangements have to be actuated with DC voltages of different ratings in order to include an operating point that is suitable for operating a Peltier module in the context of a Peltier heat pump for a tumble dryer.

The invention addresses the problem of finding a simple solution to the issue of power supply for a Peltier module.

The above object is achieved by the features according to claim 1.

The DC voltage is generated by rectifying the power supply, in particular a 230 Volt alternating current, in a power rectifier. The number of Peltier elements and the manufacturer type of the Peltier elements are selected in such a way that they are optimally adapted to said rectified power supply. In other words, the number of Peltier elements and the manufacturer type are selected in such a way that the Peltier elements of the series arrangement can be operated by actuating the series arrangement with the rectified power supply at an operating point that is at least suitable and preferably optimum for the use of the Peltier module in a Peltier heat pump.

The invention allows the Peltier module to be operated indirectly using the power supply. In particular in the context of a tumble dryer that is connected to the power supply, this is an especially simple way of providing DC voltage.

A transfer switch which has two positions is preferably provided, in the first position of which the rectified mains voltage actuates the Peltier module, and in the second position of which the rectified mains voltage does not actuate the Peltier module but the Peltier module is instead connected to another consumer.

The transfer switch takes into account the fact that another consumer in the tumble dryer can use an electric voltage that is generated as a result of the Seebeck effect if the Peltier module is exposed to a temperature difference between the heater assigned thereto and the cooler assigned thereto, without being connected to an external electric voltage. A preferred example thereof is the interior lighting of the tumble dryer. If the tumble dryer is opened, then the Peltier heat pump is automatically turned off beforehand. The interior lighting and the Peltier module consequently do not compete with each other, but are operated alternately. The transfer switch can be actuated by an actuation unit. This unit can be connected, for example, to the main control unit in the tumble dryer such that it determines, for example, whether the tumble dryer is being opened or not, in order to be able to perform the aforementioned switch-over to the interior lighting. According to a further preferred embodiment, the Peltier module, which is separated from the DC voltage that supplies it, is used as a sensor. A temperature difference between the heating and cooling component of the Peltier module can be detected from the voltage that it generates itself (as explained in the aforementioned), and as a result of the electrical resistance of the Peltier module it acquires its own operating temperature. The Peltier module is accordingly used in a variety of respects as a temperature sensor, suitable connections to the actuation unit being provided for the purpose of determining the corresponding measured values. In such cases, the actuation unit can at least optionally control the transfer switch as a function of the temperature and thus can repeatedly carry out corresponding measurements periodically. This makes it possible to introduce a regulating system within the context of which the Peltier module is disconnected if the temperature no longer falls within a critical range. The regulating temperature is dependent on the temperature sensor data and the dimensions for the actuation circuit.

It is not necessary for the actuation unit to actuate said transfer switch in order to regulate the temperature. Instead it is also possible to actuate a switch that is able to interrupt the whole power supply because it is arranged at the alternating current end of the power supply rectifier, for example, and can interrupt the alternating current supply. This then takes into account the fact that the other consumers do not require the voltage in the meantime during the temperature regulation of the Peltier module, such that the rectifier can be completely disconnected in the context of a temperature regulation.

The temperature control of the aforementioned type is used to regulate the temperature in a certain range. In addition, excess temperature protection can be provided. This can be designed in an essentially more direct way than is achieved through the mediation of a special temperature sensor. A thermoswitch can be directly connected to the Peltier module. If the Peltier module exceeds a certain temperature (at the connection point) then the thermoswitch is activated. Although the thermoswitch can be arranged at the direct current end, it is preferably arranged at the end where the alternating current is supplied to the power rectifier, however, so that it completely interrupts the supply of alternating current in the case of the temperature being too high.

In order to stabilize the rectified voltage in the power rectifier, a buffer condenser can be connected downstream of the power rectifier at the direct current end. The load current on the buffer condenser is preferably limited using a load current limiter (of the NTC type, for example). The corresponding circuitry is logically achieved such that the buffer condenser is connected in parallel to two outputs of the power rectifier and that the load current limiter is arranged in the path of the circuit between a connection of the power rectifier and a connection of the buffer condenser.

Since the circuit arrangement is intended to be operated in an electrical appliance (tumble dryer) for use by any end consumer and since said appliance is subject to statutory regulations, to comply with these regulations, in view of a possible power feedback effect, a choke has to be arranged at the alternating current end of the power rectifier for Power Factor Correction (a PFC-choke).

A preferred embodiment of the invention is described hereafter with reference to the drawing, in which the FIGURE shows the circuit diagram for the circuit arrangement according to the invention.

The FIGURE gives a schematic view of a Peltier module 1, which is intended for use in a Peltier-heat pump for a tumble dryer. The Peltier module includes Peltier elements 2 connected in series, but although twelve Peltier elements are shown here, the Peltier module does not have to have the fixed number of twelve elements. This is by no means the case, in fact the number of Peltier elements and the ratings of the Peltier elements (that is the manufacturer type of the Peltier elements) are jointly configured in such a way that the series arrangement of the Peltier elements can be operated with a voltage that is generated when the power supply is rectified. It is also conceivable to have a Peltier module comprising more than the one series arrangement shown here, the individual series arrangements usually being arranged in parallel.

In order to generate the rectified power supply, first a power supply of 230 Volt alternating current (230 Vac) is provided, the connections L and N being shown schematically here. The alternating current is rectified by a power rectifier 3, which has a conventional rectifier design. In order to stabilize the rectified voltage, a buffer condenser 4 is provided, said condenser being connected in parallel to the connections of the power rectifier 3 at the direct current end. Along the path of the circuit from one connection of the power rectifier 3 to one connection of the buffer condenser 4, there is a load limiter 5 (an NTC resistor, that is, a resistor with a negative temperature coefficient).

A thermoswitch 6 is thermally connected to the Peltier module 1. When the temperature in the Peltier module 1 is too high, the thermoswitch 6 switches at the alternating current end of the power rectifier 3, interrupts the alternating current supply and thus disconnects the Peltier module 1.

The temperature regulation can also be designed somewhat more precisely. For this purpose, a temperature sensor 7 is provided at a predetermined point on the Peltier module 1. Said sensor transmits electronic measured values to a relay actuation unit (relay actuation circuit) 11. It is likewise possible to actuate a switch 9 at the alternating current end through the relay actuation circuit 11, that is, to disconnect the whole Peltier module 1. The relay actuation circuit 11 has a further form of input, which is a DC voltage signal from the main control unit in the tumble dryer. The Peltier module 1 can therefore also be disconnected indirectly via the main control unit by means of the relay actuation circuit 11 and of the switch 9.

A transfer switch 10 (a relay) is additionally provided. With the aid of the transfer switch 10 it is likewise possible to cut the rectified power supply from the Peltier module 1 and switch the Peltier module 1 over to the interior lighting 12 of the tumble dryer. Four light-emitting diodes are shown in schematic form here for the interior lighting 12, together with an additional resistor connected in series to the light-emitting diodes. Instead of the interior lighting 12, the transfer switch 10 can also carry out a switch-over to other consumers, such as, for example, further sensors, measurement devices, controls, display elements and so on, such measurement devices being usefully incorporated into the main control unit 11 for the tumble dryer.

The transfer switch 10 is likewise actuated via the relay actuation circuit 11, and can therefore be optionally regulated as a function of the temperature recorded by the temperature sensor 7. By switching over, the Peltier module 1 is cut off from the direct voltage, as a result of which the temperature drops again. If the temperature recorded by the temperature sensor 7 falls below a certain threshold value, the actuation unit 11 becomes active again and switches over the switch 10 once again, such that the Peltier module 1 is again connected to the rectified power supply.

In order to comply with statutory regulations regarding the power feedback effect of the circuit arrangement, a choke 8 is connected upstream of the power rectifier 3 for Power Factor Correction (PFC).

The Peltier module 1 has ratings that are optimized by appropriate selection of the number of individual Peltier elements 2 and by appropriate selection of the type thereof, such that it can be operated with a rectified power supply.

In other words, where the rectified power supply is provided to operate the Peltier module 1, the operating point is optimized for use in the context of a Peltier heat pump. To optionally supply other consumers, such as interior lighting 12, for example, the transfer switch 10 can be provided, which transfer switch 10 thus usefully provides the voltage that can be generated in the Peltier module 1 by the Seebeck effect for other consumers. Protection against excessive temperatures is provided by the switch 6. With the aid of the temperature sensor 7 and the switch 9 or 10, which can be actuated by the actuation unit 11, automatic regulation of temperature is made possible.

1-8. (canceled)

9. A circuit arrangement for a Peltier module for use in a Peltier heat pump for a tumble dryer, the circuit arrangement comprising:
a Peltier module having at least one series arrangement of Peltier elements actuable by a DC voltage; and
a rectifier operatively associated with a power supply and at least one series arrangement of Peltier elements for producing a rectified DC voltage for use by said Peltier elements wherein the number of Peltier elements and the manufacturer type of Peltier elements are selected in a manner wherein the Peltier elements of the series arrangement are operated by actuating the series arrangement with the rectified power supply at an operating voltage that is suitable for the use of the Peltier module in a Peltier heat pump.

10. The circuit arrangement according to claim 9 and further comprising a transfer switch having two positions including a first position wherein the Peltier module is actuated, and a second position wherein the Peltier module is not actuated and the supply voltage is connected to another electrical device.

11. The circuit arrangement according to claim 9 and further comprising a temperature sensor for detecting the temperature on the Peltier module and transmitting a corresponding electronic measured value to an actuation unit, which at least optionally controls the transfer switch as a function of the electric measured value.

12. The circuit arrangement according to claim 9 and further comprising a temperature sensor for determining the temperature on the Peltier module and transmitting a corresponding electronic measured value to an actuation unit which controls a switch configured for interrupting the main power supply.

13. The circuit arrangement according to claim 12 wherein the rectifier has an AC side and a DC side and wherein the switch is in electrical communication with the AC side of the rectifier and is configured for interrupting the AC supply.

14. The circuit arrangement according to claim 9 and further comprising a thermoswitch disposed in thermal communication with the Peltier module, wherein the thermoswitch is configured for interrupting the AC power to the rectifier when a predetermined temperature of the Peltier module is exceeded.

15. The circuit arrangement according claim 9 and further comprising a buffer condenser for stabilizing the rectified voltage, the buffer condenser being connected downstream of the rectifier at one DC side, with the load current on the buffer condenser being limited by a load current limiter.

16. The circuit arrangement according to claim 9 and further comprising an inductor connected upstream of the rectifier at one AC side for power factor correction.
